(19) United States
(12) Patent Application Publication
(10) Pub. No.: US 2008/0183444 A1
(43) Pub. Date: Jul. 31, 2008

(54) Modeling and monitoring method and system

(76) Inventors: Anthony J. Grichnik, Peoria, IL (US); Michael Seskin, Cardiff, CA (US); Wade S. Willden, San Diego, CA (US)

Correspondence Address: CATERPILLAR/FINNEGAN, HENDERSON, L.L.P., 901 New York Avenue, NW, WASHINGTON, DC, 20001-4413, US

(21) Appl. No.: 11/698,174

(22) Filed: Jan. 26, 2007

(51) Int. Cl. G06F 17/10

(52) U.S. Cl. 703/2

(57) ABSTRACT

A computer-implemented method for monitoring machine performance includes creating one or more computational models for generating one or more estimated output values based on real-time input data. The method includes collecting real-time operational information from the machine, including real-time input data reflecting a plurality of input parameters and real-time output data reflecting one or more output parameters. The method further includes, based on the collected input data and the one or more computational models, generating a set of one or more predicted output values reflecting the one or more output parameters. The method additionally includes comparing the set of one or more predicted output values to a set of values corresponding to the real-time output data. If the set of one or more predicted output values varies more than a predetermined amount from the set of values corresponding to the real-time output data, a first notification message is provided.

### TECHNICAL FIELD

This disclosure relates generally to computer based modeling techniques and, more particularly, to methods and systems for creating process models and using the models to monitor performance characteristics of machinery.

### BACKGROUND

Mathematical models, particularly process models, are often built to capture complex interrelationships between input parameters and output parameters. Various techniques, such as neural networks, may be used in such models to establish correlations between input parameters and output parameters. Once the models are established, they may provide predictions of the output parameters based on the input parameters. The accuracy of these models may often depend on the environment within which the models operate.

Under certain circumstances, changes in the operating environment, such as a change of design and/or a change of operational conditions, may cause the models to operate inaccurately. With these inaccuracies, model performance may be degraded. A modeling system may recognize these changes and adjust the model accordingly. One such model adjusting system is described in U.S. Patent Application Publication No. 2006/0247798 A1, to Subbu et al. (the '798 Publication). The '798 Publication discloses creating a model based on historical data, training and validating the model, and then monitoring the model to ensure accuracy. However, the '798 Publication does not discuss in detail the operational use of the model in conjunction with real-time data, or monitoring the model to ensure accuracy during real-time operation. Thus, systems such as disclosed in the '798 Publication fail to describe applications for applying a computational model to real-time data streams, and further fail to employ real-time model monitoring.

Methods and systems consistent with certain features of the disclosed embodiments are directed to solving one or more of the problems set forth above.

### SUMMARY OF THE INVENTION

A first embodiment includes a computer-implemented method for monitoring machine performance. The method includes creating one or more computational models for generating one or more estimated output values based on real-time input data. The method further includes collecting real-time operational information from the machine, the real-time operational information including real-time input data reflecting a plurality of input parameters associated with the machine and real-time output data reflecting one or more output parameters associated with the machine. The method further includes, based on the collected real-time input data and the one or more computational models, generating a set of one or more predicted output values reflecting the one or more output parameters. The method additionally includes comparing the set of one or more predicted output values to a set of values corresponding to the real-time output data using one or more processes, and if the set of one or more predicted output values varies more than a predetermined amount from the set of values corresponding to the real-time output data, providing a first notification message.

A second embodiment includes a computer-implemented method for determining abnormal behavior of a group of machines. The method includes collecting real-time operational information from the machines, the real-time operational information including real-time input data reflecting a plurality of input parameters associated with the machines and real-time output data reflecting one or more output parameters associated with the machines. The method also includes providing a set of optimal input values reflecting the one or more input parameters of the machines, and providing a set of predicted output values reflecting the one or more output parameters of the machines. The method further includes determining, using one or more processes, one or more of: whether a set of values corresponding to the real-time input data is within a predetermined deviation from the set of optimal input values, and whether a set of values corresponding to the real-time output data is within a predetermined deviation from the set of predicted output values. The method additionally includes, based on the determination, indicating the operational behavior of the group of machines as either normal or abnormal, and providing the indication to a user or computer.

A third embodiment includes a system for monitoring machine performance. The system includes a computer system for creating one or more computational models for predicting output information from real-time input data. The system further includes one or more data collection devices for collecting real-time operational information associated with the machine, the real-time operational information including real-time input data values reflecting a plurality of input parameters for the machine and real-time output data values reflecting one or more output parameters for the machine. The system additionally includes a computational model for predicting output information associated with the machine based on the real-time input data values, the output information including values corresponding to the one or more output parameters. The system also includes one or more processes for comparing the predicted output information to the real-time output data values, and a first notification message provided if the values of the predicted output information vary more than a predetermined amount from the values of the real-time output data.

### BRIEF DESCRIPTION OF THE DRAWINGS

FIG. 1 illustrates an exemplary modeling and monitoring environment consistent with certain disclosed embodiments;

FIG. 2 illustrates an exemplary computer system consistent with certain disclosed embodiments;

FIG. 3 is a flowchart of an exemplary model creation process consistent with certain disclosed embodiments;

FIG. 4 is a diagram of an exemplary monitor consistent with certain disclosed embodiments;

FIG. 5 is a flowchart of an exemplary model monitoring process consistent with certain disclosed embodiments;

FIG. 6 is a diagram of an exemplary real-time monitoring system consistent with certain disclosed embodiments;

FIG. 7 is a flowchart of an exemplary real-time monitoring method consistent with certain disclosed embodiments;

FIG. 8 is a flowchart of another exemplary real-time monitoring method consistent with certain disclosed embodiments;

FIG. 9 is a flowchart of an exemplary monitoring method consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

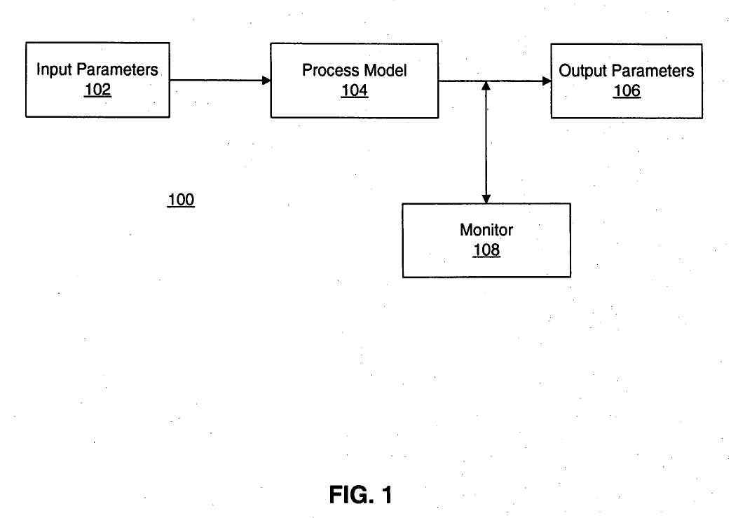

FIG. 1 illustrates a diagram of an exemplary process modeling and monitoring environment 100. As shown in FIG. 1, input parameters 102 may be provided to a process model 104 to build interrelationships between output parameters 106 and input parameters 102. Process model 104 may then predict values of output parameters 106 based on given values of input parameters 102. Input parameters 102 may include any appropriate type of data associated with a particular input to a machine or system. For example, input parameters 102 may include operational data, manufacturing data, data from design processes, financial data, and/or any other type of data. Output parameters 106 may correspond to one or more outputs from a machine or system. For example, output parameters 106 may include operational data, manufacturing data, data from design processes, financial data, and/or any other type of data.

Process model 104 may include any appropriate type of mathematical or physical models indicating interrelationships between input parameters 102 and output parameters 106. For example, process model 104 may be a neural network based mathematical model that may be trained to capture interrelationships between input parameters 102 and output parameters 106. Other types of mathematic models, such as fuzzy logic models, linear system models, and/or non-linear system models, etc., may also be used. Process model 104 may be trained and validated using data records collected from the particular application for which process model 104 is generated. That is, process model 104 may be established according to particular rules corresponding to a particular type of model using the data records, and the interrelationships of process model 104 may be verified by using the data records.

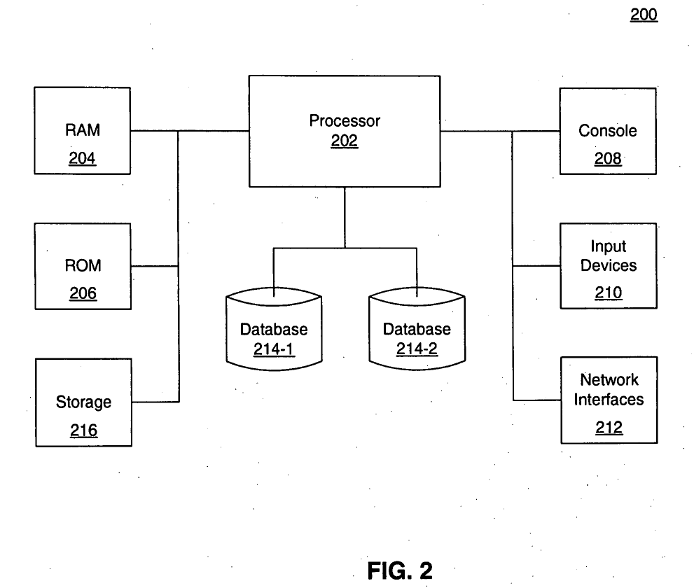

Once process model 104 is trained and validated, process model 104 may be operated to produce output parameters 106 when provided with input parameters 102. Performance characteristics of process model 104 may also be analyzed during any or all stages of training, validating, and operating. A monitor 108 may be provided to monitor the performance characteristics of process model 104. Monitor 108 may include any type of hardware device, software program, and/or a combination of hardware devices and software programs. FIG. 2 shows a functional block diagram of an exemplary computer system 200 that may be used to perform these model generation and monitoring processes.

As shown in FIG. 2, computer system 200 may include a processor 202, a random access memory (RAM) 204, a read-only memory (ROM) 206, a console 208, input devices 210, network interfaces 212, databases 214-1 and 214-2, and a storage 216. It is understood that the type and number of listed devices are exemplary only and not intended to be limiting. The number of listed devices may be changed and other devices may be added.

Processor 202 may include any appropriate type of general purpose microprocessor, digital signal processor or microcontroller. For example, in one embodiment, processor 202 may include one or more field programmable gate array (FPGA) devices, or similar devices, that provide parallel data processing. Processor 202 may execute sequences of computer program instructions to perform various processes as explained above. The computer program instructions may be loaded into RAM 204 for execution by processor 202 from a read-only memory (ROM), or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display devices or computer monitors. Input devices 210 may be provided for users to input information into computer system 200. Input devices 210 may include a keyboard, a mouse, optical or wireless computer input device, or other known input devices. Further, network interfaces 212 may provide communication connections such that computer system 200 may be accessed remotely through one or more computer networks via various communication protocols, such as transmission control protocol/internet protocol (TCP/IP), hyper text transfer protocol (HTTP), etc.

Databases 214-1 and 214-2 may contain model data and any information related to data records under analysis, such as training and testing data. Databases 214-1 and 214-2 may include any type of commercial or customized databases. Databases 214-1 and 214-2 may also include analysis tools for analyzing the information in the databases. Processor 202 may also use databases 214-1 and 214-2 to determine and store performance characteristics of process model 104, as well as real-time input and output parameter values associated with one or more machines, as discussed further below.

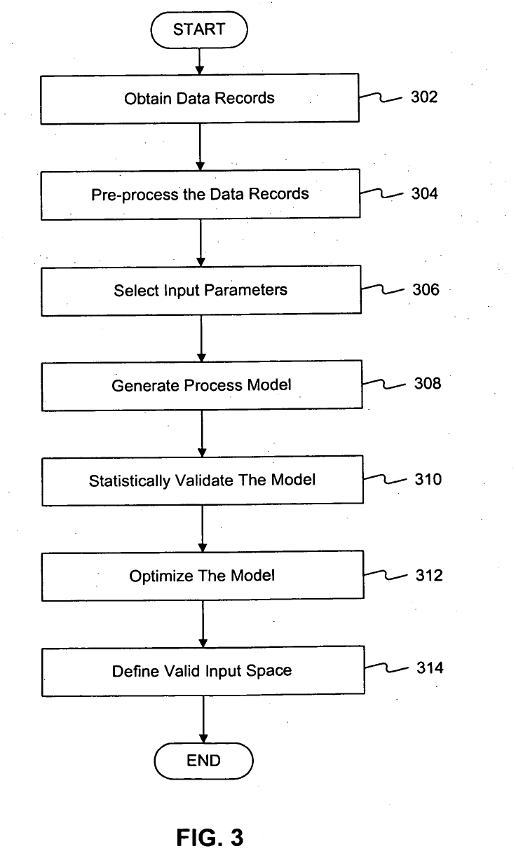

Processor 202 may perform a model generation and optimization process to generate and optimize process model 104. As shown in FIG. 3, at the beginning of the model generation and optimization process, processor 202 may obtain data records associated with input parameters 102 and output parameters 106 (step 302). For example, in an engine application, the data records may be previously collected during a certain time period from a test engine or from electronic control modules of a plurality of engines. The data records may also be collected from experiments designed for collecting such data. Alternatively, the data records may be generated artificially by other related processes, such as a design process. The data records may also include training data used to build process model 104 and testing data used to test process model 104. In addition, data records may also include simulation data used to observe and optimize process model 104. In certain embodiments, process model 104 may include other models, such as a design model. The other models may generate model data as part of the data records for process model 104.

The data records may reflect characteristics of input parameters 102 and output parameters 106, such as statistic distributions, normal ranges, and/or tolerances, etc. Once the data records are obtained (step 302), processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may then select proper input parameters by analyzing the data records (step 306).

The data records may be associated with many input variables. The number of input variables may be greater than the number of input parameters 102 used for process model 104. For example, in the engine design application, data records may be associated with gas pedal indication, gear selection, atmospheric pressure, engine temperature, fuel indication, tracking control indication, and/or other engine parameters; while input parameters 102 of a particular process may be reduced to include only gas pedal indication, gear selection, atmospheric pressure, and engine temperature.

In certain situations, the number of input variables in the data records may exceed the number of the data records and lead to sparse data scenarios. Some of the extra input variables may be omitted in certain mathematical models. The number of the input variables may need to be reduced to create mathematical models within practical computational time limits.

Processor 202 may select input parameters according to predetermined criteria. For example, processor 202 may choose input parameters by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 by any proper method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202.

Mahalanobis distance may refer to a mathematical representation that may be used to measure data profiles based on correlations between parameters in a data set. One example of a Mahalanobis distance analysis is described in U.S. Patent Application Publication No. 2006/00230018-A1, to Grichnik et al., entitled “Mahalanobis Distance Genetic Algorithm (MDGA) Method and System.” Mahalanobis distance differs from Euclidean distance in that mahalanobis distance takes into account the correlations of the data set. Mahalanobis distance of a data set X (e.g., a multivariate vector) may be represented as

MDᵢ=(Xᵢ−μₓ)Σ⁻¹(Xᵢ−μₓ)′ (1)

where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select a desired subset of input parameters such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate subset of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables 102 if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., gas pedal indication, manifold temperature and pressure, gear selection, atmospheric pressure and temperature, etc.), processor 202 may generate process model 104 to build interrelationships between input parameters 102 and output parameters 106 (step 308). Process model 104 may correspond to a computational model. As explained above, any appropriate type of neural network may be used to build the computational model. The type of neural network models used may include back propagation, feed forward models, cascaded neural networks, and/or hybrid neural networks, etc. Particular types or structures of the neural network used may depend on particular applications. Other types of models, such as linear system or non-linear system models, etc., may also be used.

The neural network computational model (i.e., process model 104) may be trained by using selected data records. For example, the neural network computational model may include a relationship between output parameters 106 (e.g., boost control, throttle valve setting, etc.) and input parameters 102 (e.g., gas pedal indication, gear selection, atmospheric pressure, and engine temperature, etc). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual outputs to determine the accuracy of the computational model. Part of the data records may be reserved for use in the validation process. Alternatively, processor 202 may also generate simulation or test data for use in the validation process.

Once trained and validated, process model 104 may be used to predict values of output parameters 106 when provided with values of input parameters 102. For example, as applied to engine design, processor 202 may use process model 104 to determine throttle valve setting and boost control based on input values of gas pedal indication, gear selection, atmospheric pressure, engine temperature, etc. In one embodiment, the output parameter value predictions may be performed in real-time to assist with machine diagnostics. For example, processor 202 may use process model 104 to predict real-time boost pressure values based on real-time input parameter values for intake temperature, engine speed, turbocharger input pressure, etc. Further, processor 202 may optimize process model 104 by determining desired distributions of input parameters 102 based on relationships between input parameters 102 and desired distributions of output parameters 106 (step 312).

Processor 202 may analyze the relationships between desired distributions of input parameters 102 and desired distributions of output parameters 106 based on particular applications of the system being modeled. In the above example, if a particular system application or use requires a higher fuel efficiency, processor 202 may use a small range of values for the throttle valve setting and use a large range of values for the boost control. Processor 202 may then run a simulation of the computational model to find a desired statistic distribution for an individual input parameter (e.g., gas pedal indication, gear selection, atmospheric pressure, engine temperature, etc). That is, processor 202 may separately determine a distribution (e.g., mean, standard variation, etc.) of the individual input parameter corresponding to the normal ranges of output parameters 106. Processor 202 may then analyze and combine the desired distributions for all the individual input parameters to determine desired distributions and characteristics for input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$

where x̅ᵢ represents the mean or expected value of an ith input; x̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, x̅ᵢ may be less than or equal to zero. A value of 3σᵢ may be added to x̅ᵢ to correct such problematic condition. If, however, x̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σⱼ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 102 such that the zeta statistic of the neural network computational model (i.e., process model 104) is maximized or optimized. An appropriate type of genetic algorithm may be used by processor 202 to search the desired distribution of input parameters with the purpose of maximizing the zeta statistic. Processor 202 may select a candidate set of input parameters with predetermined search ranges and run a simulation of the diagnostic model to calculate the zeta statistic parameters based on input parameters 102, output parameters 106, and the neural network computational model. Processor 202 may obtain x̅ᵢ and σᵢ by analyzing the candidate set of input parameters, and obtain x̅ⱼ and σⱼ by analyzing the outcomes of the simulation. Further, processor 202 may obtain |Sᵢⱼ| from the trained neural network as an indication of the impact of the ith input on the jth outcome.

Processor 202 may select the candidate set of input parameters if the genetic algorithm converges (i.e., the genetic algorithm finds the maximized or optimized zeta statistic of the diagnostic model corresponding to the candidate set of input parameters). If the genetic algorithm does not converge, a different candidate set of input parameters may be created by the genetic algorithm for further searching. This searching process may continue until the genetic algorithm converges and a desired set of input parameters 102 is identified. Processor 202 may further determine desired optimal distributions (e.g., mean and standard deviations) of input parameters based on the desired input parameter set. Once the desired distributions are determined, processor 202 may define a valid input space that may include any input parameter within the desired distributions (314).

In one embodiment, statistical distributions of certain input parameters may be impossible or impractical to control. For example, an input parameter may be associated with a physical attribute of a device that is constant, or the input parameter may be associated with a constant variable within a process model. These input parameters may be used in the zeta statistic calculations to search or identify desired distributions for other input parameters corresponding to constant values and/or statistical distributions of these input parameters.

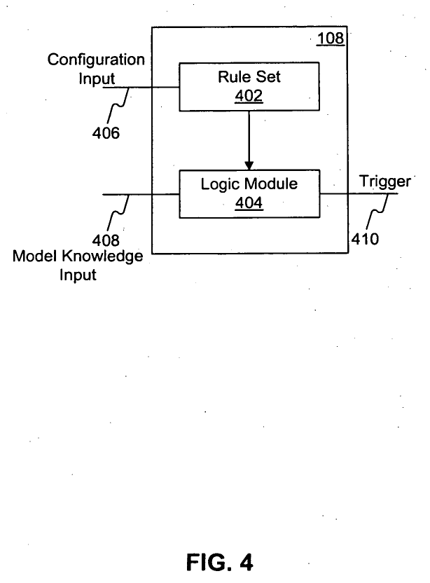

The performance characteristics of process model 104 may be monitored by monitor 108. FIG. 4 shows an exemplary block diagram of monitor 108. As shown in FIG. 4, monitor 108 may include a rule set 402, a logic module 404, a configuration input 406, a model knowledge input 408, and a trigger 410. Rule set 402 may include evaluation rules on how to evaluate and/or determine the performance characteristics of process model 104. Rule set 402 may include both application domain knowledge-independent rules and application domain knowledge-dependent rules. For example, rule set 402 may include a time out rule that may be applicable to any type of process model. The time out rule may indicate that a process model should expire after a predetermined time period without being used. A usage history of process model 104 may be obtained by monitor 108 from process model 104 to determine time periods during which process model 104 is not used. The time our rule may be satisfied when the non-usage time exceeds the predetermined time period.

In certain embodiments, an expiration rule may be set to disable process model 104 being used. For example, the expiration rule may include a predetermined time period. After process model 104 has been in use for the predetermined time period, the expiration rule may be satisfied, and process model 104 may be disabled. A user may then check process model 104 and may enable process model after checking the validity of process model 104. Alternatively, the expiration rule may be satisfied after process model 104 made a predetermined number of predictions. The user may also enable process model 104 after such expiration.

Rule set 402 may also include an evaluation rule indicating a threshold for divergence between predicted values of output parameters 106 from process model 104 and actual values corresponding to output parameters 106 from a system being modeled. The divergence may be determined based on overall actual and predicted values of output parameters 106 or based on an individual actual output parameter value and a corresponding predicted output parameter value. The threshold may be set according to particular system application requirements. In the engine design example, if a predicted throttle setting deviated from an actual throttle setting value and the deviation is beyond a predetermined threshold for throttle setting, the performance of process model 104 may be determined as degraded. Similarly, if a predicted boost pressure deviated from an actual boost pressure and the deviation is beyond a predetermined threshold for boost pressure, the performance of process model 104 may be determined as degraded. When the deviation is beyond the threshold, the evaluation rule may be satisfied to indicate the degraded performance of process model 104. Although certain particular rules are described, it is understood that any type of rule may be included in rule set 402.

In certain embodiments, the evaluation rule may also be configured to reflect process variability (e.g., variations of output parameters of process model 104). For example, an occasional divergence may be unrepresentative of a performance degrading, while certain consecutive divergences may indicate a degraded performance of process model 104. Any appropriate type of algorithm may be used to define evaluation rules.

Logic module 404 may be provided to apply evaluation rules of rule set 402 to model knowledge or data of process model 104 and to determine whether a particular rule of rule set 402 is satisfied. Model knowledge may refer to any information that relates to operation of process model 104. For example, model knowledge may include predicted values of output parameters 106 and actual values of output parameters 106 from a corresponding system being modeled. Model knowledge may also include model parameters, such as creation date, activities logged, etc. Logic module 404 may obtain model knowledge through model knowledge input 408. Model knowledge input 408 may be implemented by various communication means, such as direct data exchange between software programs, inter-processor communications, and/or web/Internet based communications.

Logic module 404 may also determine whether any of input parameters 102 are out of the valid input space. Logic module 404 may also keep track of the number of instances of any of input parameters 102 are out of the valid input space. In one embodiment, an evaluation rule may include a predetermined number of instances of input parameters being out of the valid input space.

Trigger 410 may be provided to indicate that one or more rules of rule set 402 have been satisfied and that the performance of process model 104 may be degraded. Trigger 410 may include any appropriate type of notification mechanism, such as messages, e-mails, and any other visual or sound alarms.

Configuration input 406 may be used by a user or users of process model 104 to configure rule set 402 (e.g., to add or remove rules in rule set 402). Alternatively, configuration input 406 may be provided by other software programs or hardware devices to automatically configure rule set 402. Configuration input 406 may also include other configuration parameters for operation of monitor 108. For example, configuration input 406 may include an enable or disable command to start or stop a monitoring process. When monitor 108 is enabled, model knowledge or data may be provided to monitor 108 during each data transaction or operation from process model 104. Configuration input 406 may also include information on display, communication, and/or usages.

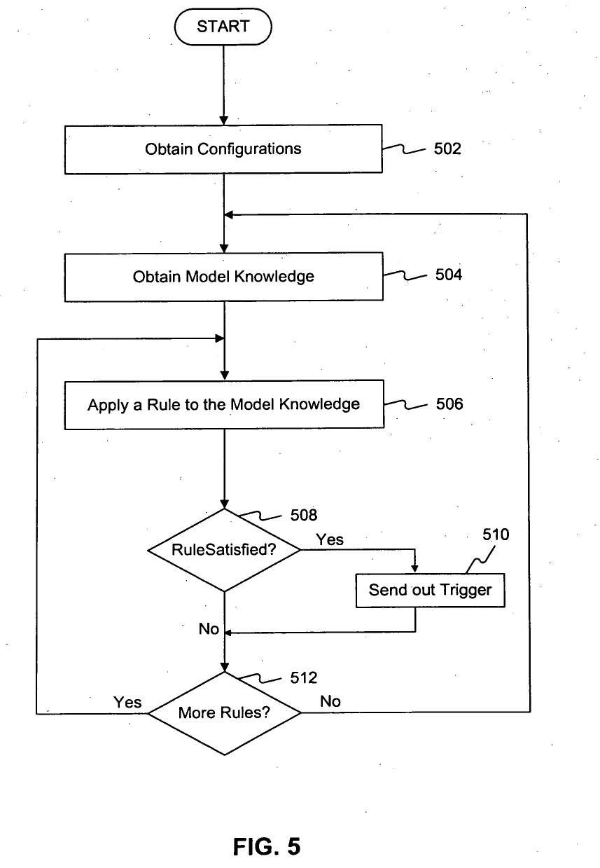

FIG. 5 shows an exemplary model monitoring process performed by processor 202. As shown in FIG. 5, processor 202 may periodically obtain configurations for monitor 108 (step 502). Processor 202 may obtain the configuration from configuration input 406. If processor 202 receives an enable configuration from configuration input 406, processor 202 may enable monitor 108. If processor 202 receives a disable configuration from configuration input 406, processor 202 may disable monitor 108 and exits the model monitoring process. Processor 202 may add all rules included in the configuration to rule set 402. For example, rule set 402 may include a monitoring rule that an alarm should be triggered if a deviation between predicted values of output parameters 106 and actual values of output parameters 106 from a system being modeled exceeds a predetermined threshold.

Processor 202 may then obtain model knowledge from model knowledge input 408 (step 504). For example, processor 202 may obtain predicted values of output parameters 106 and actual values of output parameters 106 from a system being modeled. Processor 202 may further apply the monitoring rule on the predicted values and the actual values (step 506). Processor 202 may then decide whether any rule in rule set 402 is satisfied (step 508). If processor 202 determines that a deviation between the predicted values and the actual values is beyond the predetermined threshold set in the monitoring rule (step 508; yes), processor 202 may send out an alarm via trigger 410 (step 510).

On the other hand, if the deviation is not beyond the predetermined threshold (step 508; no), processor 202 may continue the monitoring process. Processor 202 may check if there is any rule in rule set 402 that is not applied (step 512). If there are any remaining rules in rule set 402 that have not been applied (step 512; yes), processor 202 may continue applying unapplied rules in rule set 402 in step 506. On the other hand, if all rules in rule set 402 have been applied (step 512; no), processor 202 may continue the model monitoring process in step 504.

In certain embodiments, a combination of evaluation rules in rule set 402 may be used to perform compound evaluations depending on particular applications and/or particular process model 104. For example, an evaluation rule reflecting input parameters that are out of the valid input space may be used in combination with an evaluation rule reflecting deviation between the actual values and the predicted values. If processor 202 determines that input parameters 102 may be invalid as being out of the valid input space, processor 202 may determined that the predicted values may be inconclusive on determining performance of process model 104.

On the other hand, if processor 202 determines that input parameters 102 are within the valid input space, processor 202 may use the deviation rule to determine performance of process model 104 as describe above. Further, the deviation rule may include process control mechanisms to control the process variability (e.g., variation of the predicted values) as explained previously.

Alternatively, processor 202 may use an evaluation rule to determine the validity of process model 104 based on model knowledge or other simulation results independently. If processor 202 determines that process model 104 is valid, processor 202 may use the deviation rule to detect system failures outside process model 104. For example, if processor 202 determines a deviation between the predicted values and actual values, when input parameters 102 are within the valid input space and process model 104 is valid, processor 202 may determines that a system under modeling may be undergoing certain failures. Processor 202 may also determine that the failures may be unrelated to input parameters 102 because input parameters are within the valid input space.

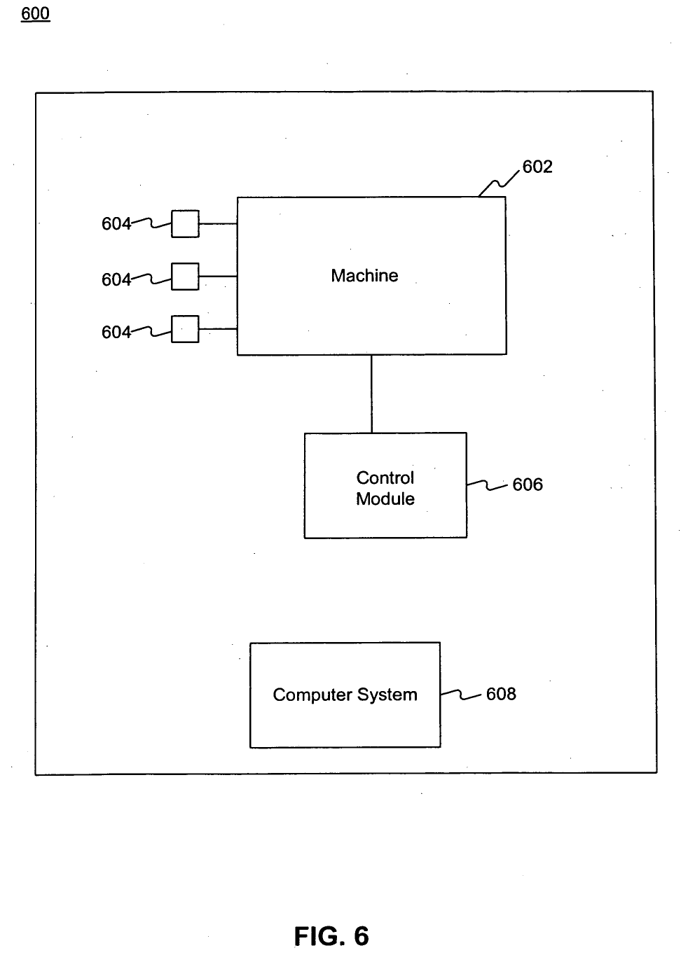

FIG. 6 shows an exemplary real-time monitoring system 600 that may use a process model, such as process model 104, to diagnose in real-time whether actual values corresponding to output parameters 106 and/or actual values corresponding to input parameters 102 deviate from predicted values beyond a threshold amount. In one embodiment, system 600 includes a machine 602 having a number of elements 604 associated with input parameters and output parameters. System 600 may additionally include control module 606, and may be associated with computer system 608.

Machine 602 may be any device having one or more input parameters and one or more output parameters, and whose behavior can be modeled using a process model. For example, in one embodiment, machine 602 may be an engine (e.g., a vehicle engine). Machine 602 may include a number of components 604. In one embodiment, elements 604 may include, for example, an air intake system (e.g., air filter/cleaner, aftercooler, air intake manifold, etc.), an exhaust system (e.g., exhaust manifold, muffler, etc.), a combustion system (e.g., cylinders, crankshaft, pistons, etc.), and a turbocharger. The turbocharger may include, for example, a compressor, a turbine, and a shaft. In one embodiment, the compressor may be connected into the air intake system between an aftercooler and an air filter. The turbine may be connected into the exhaust system between an exhaust manifold and a muffler, and the shaft may connect the compressor to the turbine.

In one embodiment, system 600 includes a control module 606, which may be used to control machine 602. For example, control module may include a fuel delivery system that includes a fuel injection system or a electronic governor. The electronic governor may control the amount of fuel delivered to the engine.

In another embodiment, system 600 includes computer system 608. Computer system 608 may receive information from the control module and/or from sensors connected to machine 602, and use the information to diagnose the machine 602. In one embodiment, computer system 608 may be a computer system such as described in connection with FIG. 2. Computer system 608 may be on-board system 600 (e.g., on-board a vehicle having engine 602) and may communicate with machine 602 via any known communication medium (e.g., wired and/or wireless, optical, etc.). Computer system 608 may be any processing system configured to implement the disclosed embodiments.

Computer system 608 may create one or more models, as described above in connection with FIGS. 1-5. In addition, computer system 608 may perform machine diagnostics based on, for example, real-time input and output parameter values, one or more sets of predicted values of output parameters based on the one or more models, and/or one or more sets of expected input parameter values.

For example, computer system 608 may collect machine information from one or more sensors or from control module 606. In one embodiment, machine information may be collected from one or more fuel temperature sensors, intake manifold pressure (boost pressure) sensors, intake manifold temperature sensors, filtered air pressure sensors, and/or filtered air temperature sensors. The control module 606 may also transmit other sensor information and other calculated machine parameters to the computer system 608. For example, the control module 606 may calculate the mass flow rate of fuel into an engine as a function of engine speed (measured) and amount of fuel delivered to the engine (e.g., “rack position”). Control module 606 may relay calculated information to the computer system 608. In one embodiment, control module 606 also receives sensor information relating to engine speed, timing advance, and rack position and/or fuel rate, and relays this information to the computer system 608.

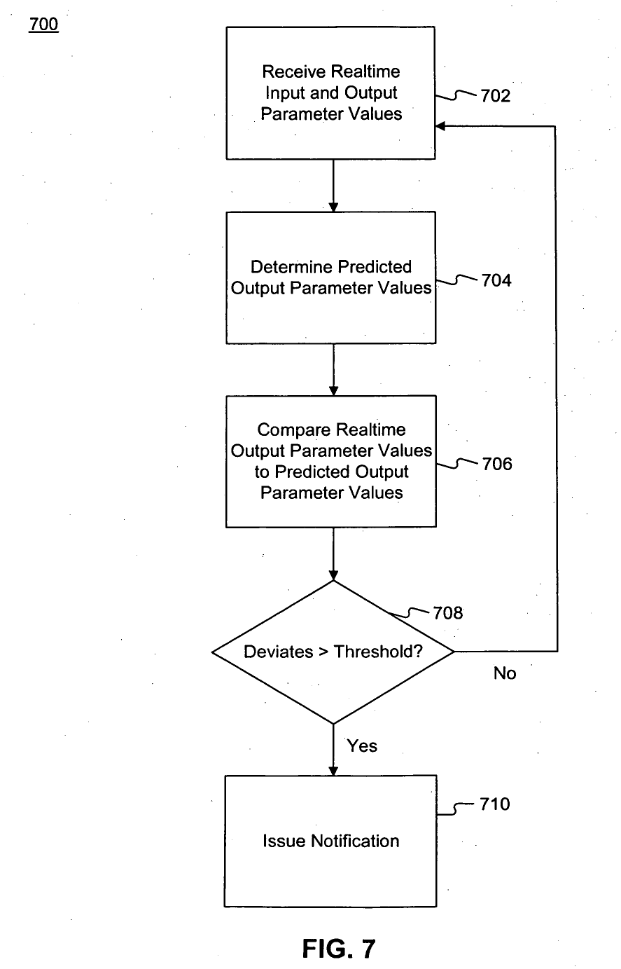

In one embodiment, computer system 608 performs real-time, on-board diagnostic routines using one or more process models, such as process model 104. For example, as shown in FIG. 7, computer system 608 may receive a real-time stream of data values relating to one or more input parameters associated with machine 602, and a real-time stream of data values relating to one or more output parameters associated with machine 602 (step 702). In one embodiment, the input parameters may include one or more of turbocharger input temperature, turbocharger input pressure, intake manifold temperature, engine speed, engine load variation, and engine fuel input; and the output parameters may include, for example, boost pressure (e.g., engine intake manifold pressure).

In step 704, computer system 608 may use one or more process models to determine, in real-time, a set of predicted output parameter data values based on the real-time stream of input parameter data values. For example, computer system 608 may use model 104 to predict one or more boost pressure values based on a set of real-time input parameter data including one or more turbocharger input temperature values, turbocharger input pressure values, intake manifold temperature values, engine speed values, engine load variation values, and/or engine fuel input values.

In step 706, computer system 608 compares the set of received real-time output parameter values to the set of predicted output parameter values, to determine whether the two sets of information deviate from each other by more than a particular threshold. For example, computer system 608 may calculate predicted boost pressure values in real-time by running real-time actual input parameter values through a process model. If the real-time actual boost pressure at a given moment deviates from the predicted boost pressure at that moment, then computer system 608 may issue a notification indicating degraded performance of the engine. In an alternative embodiment, the computer system may compare a series of actual values (e.g., a set of actual boost pressure values over a period of time) to a series of predicted values (e.g., a set of predicted boots pressure values based on real-time input parameter values over a period of time) to determine whether the series of actual parameter values deviate from the predicted parameter values by more than a particular threshold.

If the predicted output parameter value or values deviate from the actual output parameter value or values by more than the threshold (step 708, “yes”), then computer system 608, or another component of system 600, may issue a notification message (step 710). The notification message may indicate to a user or to computer system 608 a degraded performance of machine 602, or some other problem with machine 602. The notification message may include a visual indicator (e.g., light, computer screen image), audio indicator (e.g., beep or other warning sound), vibration indicator, computer instruction (e.g., e-mail, text message, message to a computer to perform a particular task, etc.), or any message that notifies a user or computer system of the deviation.

If the predicted output parameter value or values do not deviate from the actual output parameter value or values by more than the threshold (step 708, “no”), then in one embodiment, no notification is issued, and the monitoring system continues monitoring the machine performance (step 702).

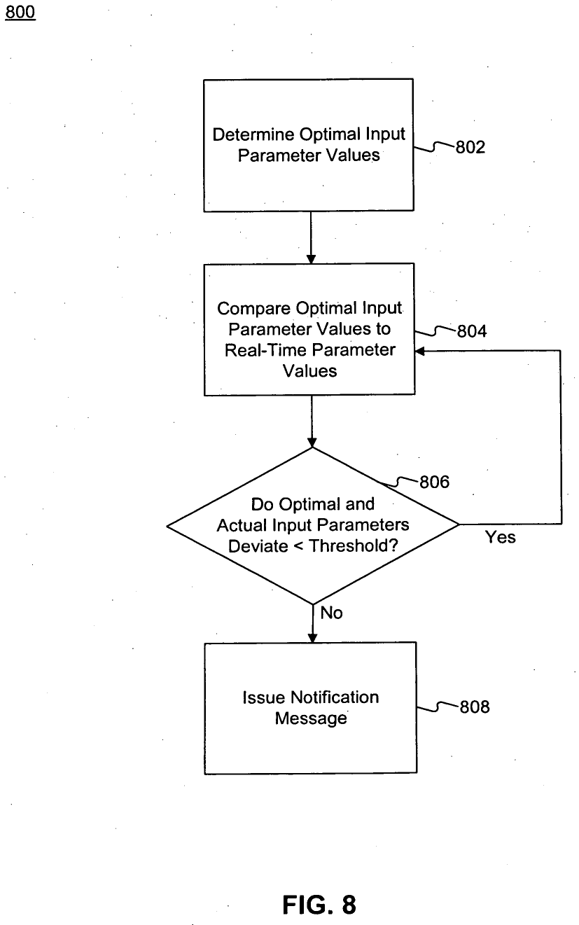

In another embodiment, a separate notification may be issued when the set of real-time actual input parameter values deviates from a set of optimal input parameter values by more than a particular threshold. FIG. 8 depicts an exemplary method 800 for issuing such a notification. For example, in step 802, a computer system (e.g., computer system 608) may determine a set of optimal input parameter values for machine 602. In one embodiment, these values may be determined based on machine specifications provided by a manufacturer. In another embodiment, the values may be determined based on prior testing or analysis of the input parameters under one or more particular conditions. In yet another embodiment, the values may correspond to values used to create the process model 104 for system 600, or values determined based on a zeta statistic.

Based on the optimal input parameter values, a valid input space may be defined. The valid input space may include, for example, a set of values within a standard deviation of a particular range. In one embodiment, the range may be derived from expected values set by a manufacturer, from testing or analysis of the input parameters, from a zeta statistic analysis, or from other sources.

In step 804, the optimal input parameter values are compared to a set of actual, real-time input parameter values. The comparison may include determining a number or percentage of actual input parameter values that are outside the particular range or valid input space defined in step 802. In one embodiment, the comparison may include determining a mahalanobis distance between the set of values in the valid input space and the set of values corresponding to the actual, real-time input parameters. If the number or percentage of actual input parameter values outside the range or valid input space is above a threshold, or if the mahalanobis distance is greater than a particular threshold, then there may be a problem with the model, or there may be an unexpected actual input that is affecting the system 600,

For example, in one embodiment, a process model may be created under certain conditions (e.g., outside temperature, air pressure, humidity, etc.) that affect the input parameters used to create the model. The model may then be used for real-time diagnostics, as discussed in connection with FIG. 7 above. The real-time diagnostics compare actual values to optimal values based in part on the created model. Therefore, if conditions change that affect the process model itself, the model may in fact need re-calibration to ensure that the diagnostics system is working properly. Alternatively, or additionally, an unexpected and untested input parameter may cause actual parameter values to deviate from an optimal set of values.

In one embodiment, the comparison step 804 determines whether the optimal input parameter values used to create the process model used for diagnostics fall within a particular deviation from the actual real-time input parameter values. If so (step 806, “yes”) then the model is still properly calibrated, and unexpected input parameters are likely not present. Accordingly system 600 may continue to monitor the real-time data values. However, if the optimal input parameter values used to create the process model used for diagnostics fall outside a particular deviation from the actual real-time input parameter values (step 806, “no”), a notification message may be issued (step 808).

The notification message may be in any appropriate form, such as a visual, audio, or vibrational alarm, an electronic message, etc. In one embodiment, the notification may be an electronic message (e.g., e-mail, text, etc.) that informs a user or computer system that the model may be out of calibration or that an unexpected input parameter (e.g., debris in the engine, a broken part, etc.) may be present. In another embodiment, the notification may be a trigger message that instructs system 600 or machine 602 to shut off or temporarily cease operation, or instructs the model 104 to disable. For example, it may be dangerous to run the machine without a proper diagnostics process running or with an unexpected parameter present. Therefore, if the computer system 608 receives a notification message indicating a problem with inputs or with the model, the computer system 608 may instruct the machine 602 or itself to shut down to avoid any potential damage. As such, the optimal input parameter values provided to system 600 may be used to regulate machine 602's operation to a range of optimal input parameter values expected to result in desired output parameter values.

In one embodiment, a number of deviation or mahalanobis distance thresholds may be set such that if a first threshold is exceeded, a user or computer system is merely informed of a potential problem, but if a second threshold is exceeded, the system 600, machine 602, or model 104 automatically shuts off or temporarily ceases operating. Further, in one embodiment, if the first or second threshold is exceeded, new parts may be automatically ordered, and/or machine repairs may be automatically scheduled.

In one embodiment, system 600 may include a plurality of machines of the same type (e.g., engines, hydraulic systems, etc.), which each include a plurality of input parameters and a plurality of output parameters. The machines may be monitored as a group to determine if there is an overall problem with one or more of the input parameters and/or output parameters that is affecting performance of individual machines or the machines as a group. For example, a subset of engines may collectively have unexpectedly low boost pressure, which may indicate that those engines were manufactured differently than other engines, and need to be repaired. As a result, an alarm or other indicator message (e.g., e-mail, printed report, text message, etc.) may be issued to notify a person or computer system that further analysis of the machines may be warranted.

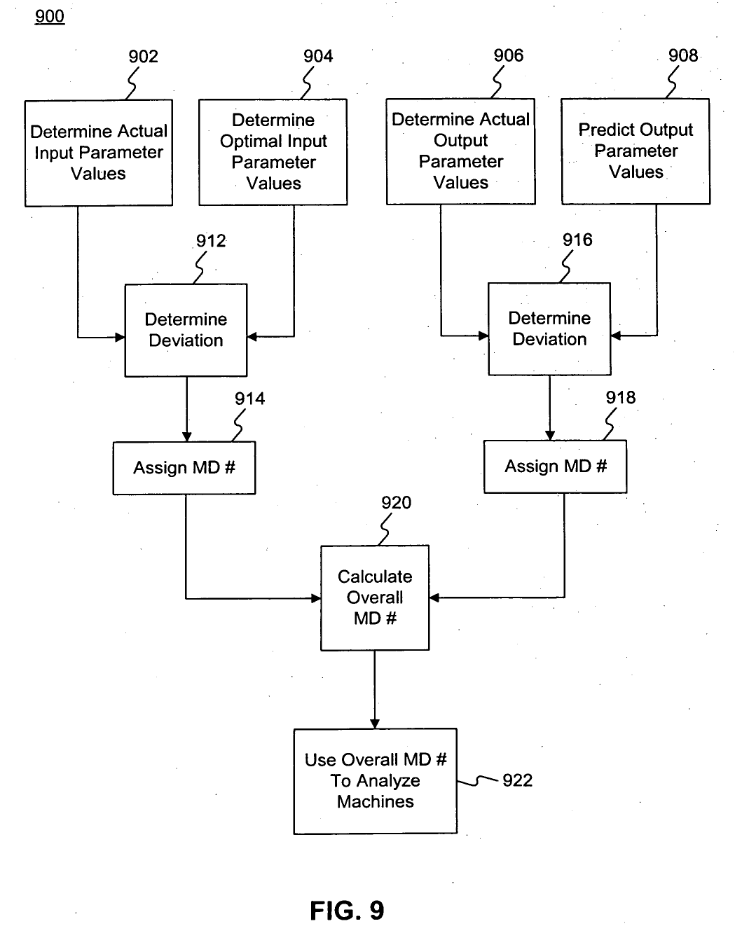

FIG. 9 depicts an exemplary method 900 for analyzing both input and output parameters of a group of machines to determine if the machines are exhibiting unexpected or abnormal behavior. In step 902, actual input parameter values (e.g., turbocharger input temperature, turbocharger input pressure, intake manifold temperature, engine speed, engine load variation, engine fuel input, etc.) are determined for each of the group of machines. For example, the values may be collected from components of the machines (e.g., components 604), from one or more control modules of the machines (e.g., control module 606), from computer systems associated with the machines (e.g., computer system 608), or from any other data collection device associated with the machines. In one embodiment, the values are collected by and stored in a single computer system. In another embodiment, the values may be stored in a distributed manner by a plurality of computer systems. The computer system or systems (hereinafter collectively referred to as “central computer system”) may store the values, for example, in a database.

In step 904, optimal input parameter values for the machines are determined using, for example, one or more of the methods described above. For example, the values may be based on machine specifications provided by a manufacturer, prior testing or analysis of the input parameters under one or more particular conditions, a zeta statistic analysis, or other methods. The central computer system may store these optimal values, for example, in a database or other known data storage mechanism.

In step 906, actual output parameter values (e.g., boost pressure, exhaust temperature, etc.) are determined in a manner similar to that described in step 902. For example, they may be collected from various sensors, control modules, and/or computer systems associated with the machines, and may be stored in a database or other storage structure at a central computer system.

In step 908, output parameter values for the machines are predicted using, for example, one or more of the methods described above. For example, the values may be determined based on actual input parameter values run through a process model. Furthermore, the values may be determined based on a manufacturer's or designer's specifications, or by testing and/or analysis of the machines. The predicted output parameter values may also be stored in a database or other storage structure (e.g., a central computer system). Although steps 902, 904, 906, and 908 are described above in a particular order, they may occur in any order.

In step 912, the system storing the actual and optimal input parameter values, or another system, determines a deviation between the actual values determined in step 902 and the optimal values determined in step 904. The deviation may be determined using any of the methods described previously. Further, the deviation may be determined on a machine-by-machine bases, or by combining input data from a plurality of machines. For example, in one embodiment, a mahalanobis distance may be determined between the optimal input parameter values and the actual input parameter values for each machine in the group of machines. The mahalanobis distance may be, for example, a maximum mahalanobis distance between the data sets, or an average mahalanobis distance between the data sets. In one embodiment, an “MD rating” is assigned (step 914) to different ranges of mahalanobis distance values (e.g., a “10” is given to a range above a particular deviation, a “9” is given for a range having a lesser deviation, etc.).

In step 916, the system storing the actual and predicted output parameter values, or another system, determines a deviation between the actual values determined in step 906 and the predicted values determined in step 908. The deviation may be determined using any of the methods described previously. Further, the deviation may be determined on a machine-by-machine bases, or by combining output data from a plurality of machines. For example, in one embodiment, a mahalanobis distance may be determined between the predicted output parameter values and the actual output parameter values for each machine in the group of machines. The mahalanobis distance may be, for example, a maximum mahalanobis distance between the data sets, or an average mahalanobis distance between the data sets. In one embodiment, an “MD rating” is assigned (step 918) to different ranges of mahalanobis distance values (e.g., a “10,” “9,” etc.). In another embodiment, a Euclidean distance may be determined between the optimal input parameter values and actual input parameter values and between predicted output parameter values and the actual output parameter values for each machine or group of machine, and an associated “EU rating” may be assigned. Although steps 912 and 916, as well as 914 and 918 are described in a particular order, they may occur in any order.

Based on the MD ratings for input and output parameters determined in steps 914 and 918, an overall MD rating may be determined (step 920) for individual machines and/or sets of machines. In one embodiment, the overall MD rating may be calculated as an average between input MD ratings and output MD ratings for each machine or set of machines. Thus, each machine or set of machines may be associated with an MD rating. As such, individual machines and/or sets of machines may be ranked by order of their MD ratings. This ranking system allows a user or computer system to easily determine (step 922) which machines or sets of machines need to be further analyzed for possible maintenance, repair, design changes, or other improvements.

Method 900 therefore provides a reliable way to ensure that a group of machines provided by a manufacturer, designer, or other company or entity, are kept in good working condition. Upon discovery of potential problems among the group of machines, maintenance, repairs, design changes, and/or other improvements may be administered.

### INDUSTRIAL APPLICABILITY

The disclosed methods and systems can provide a desired solution for model performance monitoring, modeling process monitoring, model operation monitoring, and/or diagnostics monitoring in a wide range of applications, such as engine design, control system design, service process evaluation, financial data modeling, manufacturing process modeling, etc. The disclosed process model monitor may be used with any type of process model to monitor the model performance of the process model and to provide the process model a self-awareness of its performance. When provided with the expected model error band and other model knowledge, such as predicted values and actual values, the disclosed monitor may set alarms in real-time when the model or system performance declines.

The disclosed monitor may also be used as a quality control tool during the modeling process. Users may be warned when using a process model that has not been in use for a period of time. The users may also be provided with usage history data of a particular process model to help facilitate the modeling process.

The disclosed monitor may also be used together with other software programs, such as a model server and web server, such that the monitor may be used and accessed via computer networks.

Other embodiments, features, aspects, and principles of the disclosed exemplary systems will be apparent to those skilled in the art and may be implemented in various environments and systems.

What is claimed is:

1. A computer-implemented method for monitoring machine performance, comprising:
creating one or more computational models for generating one or more estimated output values based on real-time input data;
collecting real-time operational information from the machine, the real-time operational information including real-time input data reflecting a plurality of input parameters associated with the machine and real-time output data reflecting one or more output parameters associated with the machine;
based on the collected real-time input data and the one or more computational models, generating a set of one or more predicted output values reflecting the one or more output parameters;
comparing the set of one or more predicted output values to a set of values corresponding to the real-time output data using one or more processes; and
if the set of one or more predicted output values varies more than a predetermined amount from the set of values corresponding to the real-time output data, providing a first notification message.

2. The computer-implemented method of claim 1, further including:
providing a set of optimal input values reflecting the one or more input parameters of the machine;
comparing the set of optimal input values to a set of values corresponding to the real-time input data using one or more processes; and
if the set of optimal input values varies more than a predetermined amount from the set of values corresponding to the real-time input data, providing a second notification message.

3. The computer-implemented method of claim 2 further including one or more of:
using the first notification message to notify a user of machine performance; and
using the second notification message to perform one or more of: notifying a user of machine performance, shutting off at least a portion of the machine, ordering parts related to the machine, and scheduling one or more repairs for the machine.

4. The computer-implemented method of claim 1, wherein the predetermined amount depends on an evaluation of one or more mahalanobis distances.

5. The computer-implemented method of claim 1, wherein the input parameters include one or more of intake manifold temperature, fuel temperature, turbocharger input temperature, turbocharger input pressure, engine speed, fuel input into the engine, and load variation, and the output parameters include one or more of boost pressure and exhaust temperature.

6. The computer-implemented method of claim 1, wherein creating the computational model includes using one or more of dimension reduction, model training, and model validation.

7. The computer-implemented method of claim 1, further including creating the computational model by:
obtaining data records associated with one or more input variables and the one or more output parameters;
selecting the plurality of input parameters from the one or more input variables;
generating the computational model indicative of interrelationships between the plurality input parameters and the one or more output parameters based on the data records; and
determining desired respective statistical distributions of the plurality of input parameters of the computational model.

8. The computer-implemented method of claim 7, further including selecting the plurality of input parameters from the one or more input variables by:
pre-processing the data records; and
using a genetic algorithm to select the plurality of input parameters from one or more input variables based on a mahalanobis distance between a normal data set and an abnormal data set of the data records.

9. The computer-implemented method of claim 7, further including determining desired respective statistical distributions by:
determining a candidate set of input parameters with a maximum zeta statistic using a genetic algorithm;
determining the desired statistical distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model; and
using the desired statistical distribution of the input parameters to regulate operation of the machine.

10. A computer-implemented method for determining abnormal behavior of a group of machines, comprising:
collecting real-time operational information from the machines, the real-time operational information including real-time input data reflecting a plurality of input parameters associated with the machines and real-time output data reflecting one or more output parameters associated with the machines;
providing a set of optimal input values reflecting the one or more input parameters of the machines;
providing a set of predicted output values reflecting the one or more output parameters of the machines;
determining, using one or more processes, one or more of:
whether a set of values corresponding to the real-time input data is within a predetermined deviation from the set of optimal input values, and
whether a set of values corresponding to the real-time output data is within a predetermined deviation from the set of predicted output values;
based on the determination, indicating the operational behavior of the group of machines as either normal or abnormal; and
providing the indication to a user or computer.

11. The computer-implemented method of claim 10, wherein:
the real-time input data includes data gathered from a plurality of machine sensors; and
the real-time output data includes data gathered from one or more machine sensors or calculated based on data gathered from one or more machine sensors.

12. The computer-implemented method of claim 10, wherein the predetermined deviation depends on an evaluation of one or more mahalanobis distances.

13. The computer-implemented method of claim 12, wherein the predetermined deviation is a measure of abnormality indicated by a mahalanobis distance rating.

14. The computer-implemented method of claim 10, wherein the predetermined deviation depends on an evaluation of one or more Euclidean distances.

15. A system for monitoring machine performance, comprising:
a computer system for creating one or more computational models for predicting output information from real-time input data;
one or more data collection devices for collecting real-time operational information associated with the machine, the real-time operational information including real-time input data values reflecting a plurality of input parameters for the machine and real-time output data values reflecting one or more output parameters for the machine;
a computational model for predicting output information associated with the machine based on the real-time input data values, the output information including values corresponding to the one or more output parameters;
one or more processes for comparing the predicted output information to the real-time output data values; and
a first notification message provided if the values of the predicted output information vary more than a predetermined amount from the values of the real-time output data.

16. The system of claim 15, further including:
one or more processes for:
determining predicted input data values reflecting the plurality input parameters, and
comparing the predicted input data values to the real-time input data values using one or more processes; and
a second notification message, the second notification message provided if the values of the predicted input information vary more than a predetermined amount from the real-time input data values.

17. The system of claim 16 wherein:
the first notification message to notifies a user of machine performance; and
the second notification message performs one or more of: notifying a user of machine performance, shutting off at least a portion of the machine, ordering parts related to the machine, and scheduling one or more repairs for the machine.

18. The system of claim 15, wherein the predetermined amount depends on an evaluation of one or more mahalanobis distances.

19. The system of claim 15, wherein the computational model is created by:
obtaining data records associated with one or more input variables and the one or more output parameters;
selecting the plurality of input parameters from the one or more input variables;
generating the computational model indicative of interrelationships between the plurality input parameters and the one or more output parameters based on the data records; and
determining desired respective statistical distributions of the plurality of input parameters of the computational model.

20. The system of claim 19, wherein the plurality of input parameters are selected from the one or more input variables by:
pre-processing the data records; and
using a genetic algorithm to select the plurality of input parameters from one or more input variables based on a mahalanobis distance between a normal data set and an abnormal data set of the data records.

21. The system of claim 19, wherein the desired respective statistical distributions are determined by:
determining a candidate set of input parameters with a maximum zeta statistic using a genetic algorithm;
determining the desired statistical distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model; and
wherein the desired statistical distribution of the input parameters is used to regulate operation of the machine.
